(19) United States
(12) Patent Application Publication
(10) Pub. No.: US 2009/0103911 A1
(43) Pub. Date: Apr. 23, 2009

(54) CAMERA WITH BUILT-IN STROBE

(75) Inventors: Takahiro IKEMIZO, Osaka (JP); Koji YASUDA, Osaka (JP)

Correspondence Address: HAMRE, SCHUMANN, MUELLER & LARSON P.C., P.O. BOX 2902-0902, MINNEAPOLIS, MN, 55402, US

(73) Assignee: Panasonic Corporation, Osaka (JP)

(21) Appl. No.: 12/251,867

(22) Filed: Oct. 15, 2008

(30) Foreign Application Priority Data
Oct. 18, 2007 (JP) 2007-271728

(51) Int. Cl. G03B 15/06

(52) U.S. Cl. 396/174; 396/175

(57) ABSTRACT

A camera with a built-in strobe is provided, which includes a non-contact-type unit as means for detecting that a strobe device is at a light emittable position and in which a degree of design freedom can be enhanced. The camera with a built-in strobe includes a camera body, a movable strobe device provided at the camera body, and a detecting unit that includes a Hall element provided at the camera body and a magnet provided at the strobe device and detects that the strobe device is at a light emittable position.

### BACKGROUND OF THE INVENTION

1. Field of the Invention

The present invention relates to a camera with a built-in strobe, and in particular, to a camera with a built-in strobe having a pop-up mechanism that allows a strobe device to move between a housed position and a protruding position.

2. Description of Related Art

In a camera with a built-in strobe having the above-mentioned pop-up mechanism, it is desired that a strobe device is moved to a protruding position and allowed to emit light after it is confirmed that the strobe device is exactly at the protruding position.

Conventionally, as means for detecting that a strobe device is at a protruding position (i.e., at a light emittable position where the strobe device is capable of emitting light), a contact-type unit such as a push switch has been used, which is pushed to be placed in an “ON” state when the strobe device is at a housed position and is placed in an “OFF” state when the strobe device is at a protruding position.

However, in such a contact-type unit, there is a limit to the switching timing between ON and OFF, and in the case where the strobe device is stopped by a so-called malicious operation while moving from the housed position to the protruding position and emits light, a camera body may be burnt. Furthermore, such a contact-type unit may be broken due to the impact at a time of dropping of the camera body. Particularly, in the case of using a push switch, the push switch is energized when the strobe device is housed, so that contact members are welded while the push switch is being pushed, which may make it impossible to switch between ON and OFF.

Recently, as means for detecting that the strobe device is at a light emittable position, a non-contact-type unit using a reflector, and a reflective photointerrupter having a projecting portion and a light-receiving portion has been proposed (see, for example, JP 7(1995)-36094 A).

However, in the non-contact-type unit proposed in JP 7(1995)-36094 A, for example, the light-receiving portion receives light that is radiated from a light-emitting diode (LED) as the projecting portion and reflected by the reflector, thereby detecting that a strobe device is at a light emittable position. Therefore, the attachment position of the reflector and the reflective photointerrupter is limited. This causes a problem such as a low degree of design freedom.

### SUMMARY OF THE INVENTION

Therefore, with the foregoing in mind, it is an object of the present invention to provide a camera with a built-in strobe, which includes a non-contact-type unit as means for detecting that a strobe device is at a light emittable position and in which the degree of design freedom can be enhanced.

In order to achieve the above object, a camera with a built-in strobe according to the present invention includes a camera body, a movable strobe device provided at the camera body, and a detecting unit that includes a Hall element provided at the camera body and a magnet provided at the strobe device and detects that the strobe device is at a light emittable position.

According to the present invention, a non-contact-type unit including a Hall element and a magnet is used as the detecting unit detecting that the strobe device is at a light emittable position. Therefore, there arise no problems peculiar to the contact-type unit, such as those in which contact members are welded while a push switch or the like is being pushed, making it impossible to switch between ON and OFF. Furthermore, the strobe device is configured so as to be placed at the light emittable position when the output voltage from the Hall element reaches a predetermined threshold value or less, whereby the switching position between the emission prohibition and the emission permission of the strobe device can be set freely, and in particular, the switching between the emission prohibition and the emission permission of the strobe device can be performed at a position close to the protruding position. Consequently, the following problem can be solved: in the case where the strobe device is stopped by a so-called malicious operation while moving from the housed position to the protruding position and emits light, a camera body may be burnt. Furthermore, the strobe device is configured so as to be placed at a light emittable position when the output voltage from the Hall element reaches a predetermined threshold value or less as described above, whereby the attachment position of the Hall element and the magnet can be determined freely to some degree, so that the degree of design freedom can be enhanced.

### BRIEF DESCRIPTION OF THE DRAWINGS

FIG. 1 is a perspective view showing an outer appearance of a camera with a built-in strobe when a strobe device is placed at a housed position, viewed from a photographer side, in Embodiment 1 of the present invention.

FIG. 2 is a perspective view showing an outer appearance of the camera with a built-in strobe when the strobe device is placed at a protruding position, viewed from the photographer side, in Embodiment 1 of the present invention.

FIG. 3 is a perspective view showing an outer appearance of the camera with a built-in strobe when the strobe device is placed at the housed position, viewed from a subject side, in Embodiment 1 of the present invention.

FIG. 4 is a perspective view showing an outer appearance of the camera with a built-in strobe when the strobe device is placed at the protruding position, viewed from the subject side, in Embodiment 1 of the present invention.

FIG. 5 is a side view showing a configuration around the strobe device when the strobe device is placed at the housed position in the camera with a built-in strobe in Embodiment 1 of the present invention.

FIG. 6 is a partially cut-away side view showing a configuration around the strobe device when the strobe device is placed at the protruding position in the camera with a built-in strobe in Embodiment 1 of the present invention.

FIG. 7 is a schematic block diagram showing a light-emitting circuit of the strobe device in Embodiment 1 of the present invention.

FIG. 8 is a perspective view showing an outer appearance of a camera with a built-in strobe when a strobe device is placed at a housed position, viewed from a photographer side, in Embodiment 2 of the present invention.

FIG. 9 is a perspective view showing an outer appearance of the camera with a built-in camera when the strobe device is placed at a bounce photographing position (half-protruding position), viewed from the photographer side, in Embodiment 2 of the present invention.

FIG. 10 is a perspective view showing an outer appearance of the camera with a built-in strobe when the strobe device is placed at a normal photographing position (protruding position), viewed from the photographer side, in Embodiment 2 of the present invention.

FIG. 11 is a schematic block diagram illustrating a light-emitting circuit of the strobe device in Embodiment 2 of the present invention.

FIGS. 12A and 12B are schematic views showing another example of a pop-up operation of the strobe device in Embodiment 2 of the present invention.

### DETAILED DESCRIPTION OF THE INVENTION

A camera with a built-in strobe of the present invention can adopt the following various aspects based on the above-mentioned configuration.

More specifically, in the configuration of the above-mentioned camera with a built-in strobe of the present invention, it is preferred that the strobe device has a plurality of light emittable positions. Furthermore, in this case, it is preferred that the plurality of light emittable positions are a normal photographing position and a bounce photographing position. In the case where the strobe device has a plurality of light emittable positions as described above, when the output voltages from the Hall element reaches predetermined values corresponding to a plurality of light emittable positions, the detecting unit may output a detection signal indicating that the strobe device is placed at a light emittable position.

Furthermore, in the configuration of the above-mentioned camera with a built-in strobe of the present invention, it is preferred that the strobe device is capable of rotating with respect to the camera body, and the Hall element and the magnet are placed in a vicinity of a rotation shaft of the strobe device. According to the preferred example, the output voltage from the Hall element in the case where the strobe device is in the vicinity of the protruding position can be kept to be a relatively large value. Therefore, the threshold value of the output voltage from the Hall element when the switching between the emission prohibition and the emission permission of the strobe device is performed does not decrease so largely, so that the switching between the emission prohibition and the emission permission of the strobe device can be performed exactly and stably.

Furthermore, in the configuration of the above-mentioned camera with a built-in strobe of the present invention, it is preferred that the Hall element and the magnet are placed in a plane perpendicular to the rotation shaft.

Furthermore, in the configuration of the above-mentioned camera with a built-in strobe of the present invention, it is preferred that the magnet is a permanent magnet. In this case, for example, a samarium-cobalt based rare earth magnet or a neodymium based rare earth magnet can be used as the permanent magnet.

Hereinafter, the present invention will be described more specifically by way of embodiments.

### Embodiment 1

1. Overall Configuration of a Camera with a Built-In Strobe

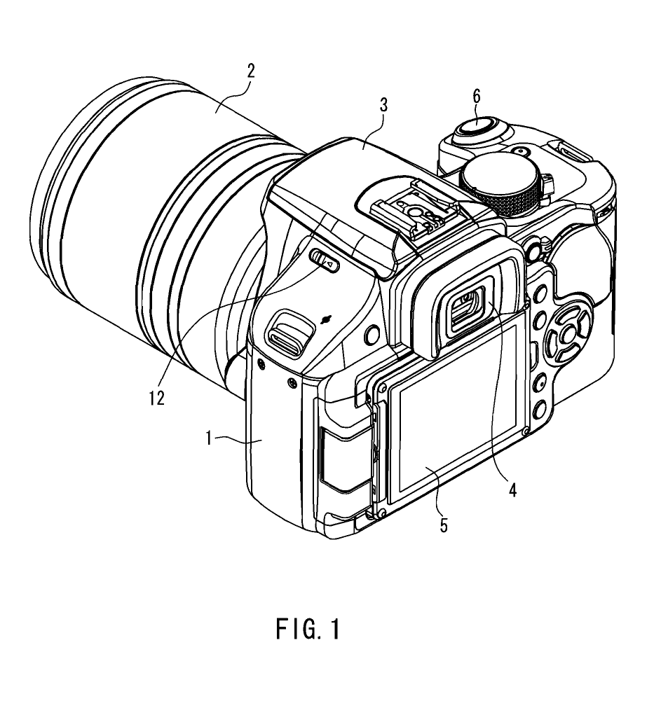

First, the overall configuration of a camera with a built-in strobe will be described with reference to FIGS. 1 to 4.

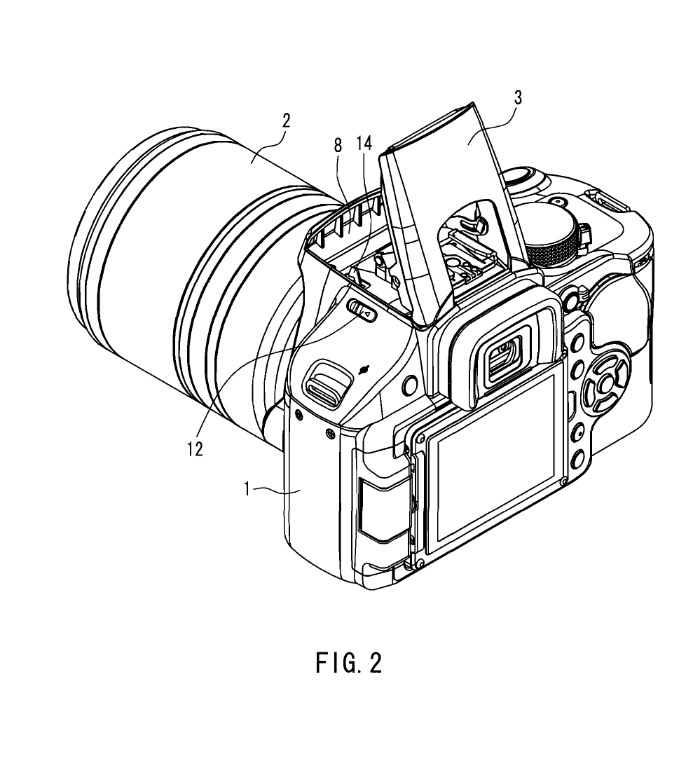

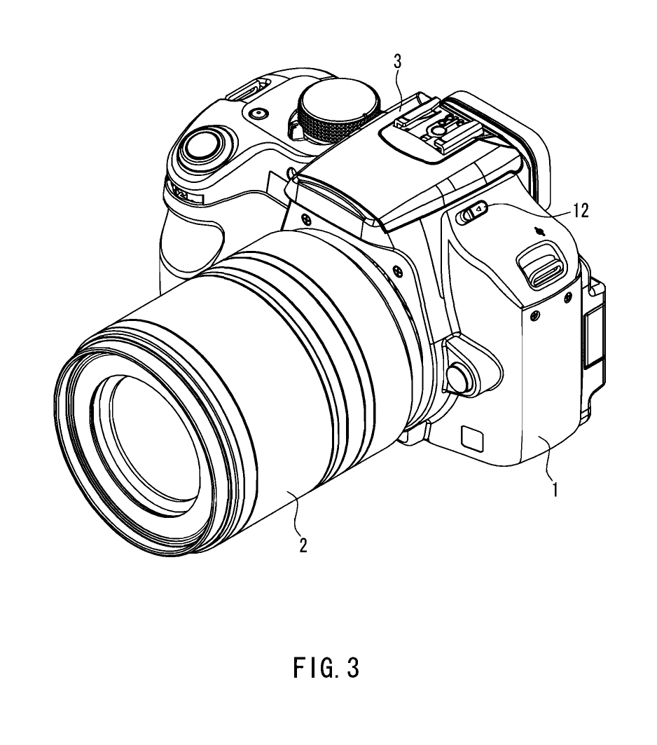

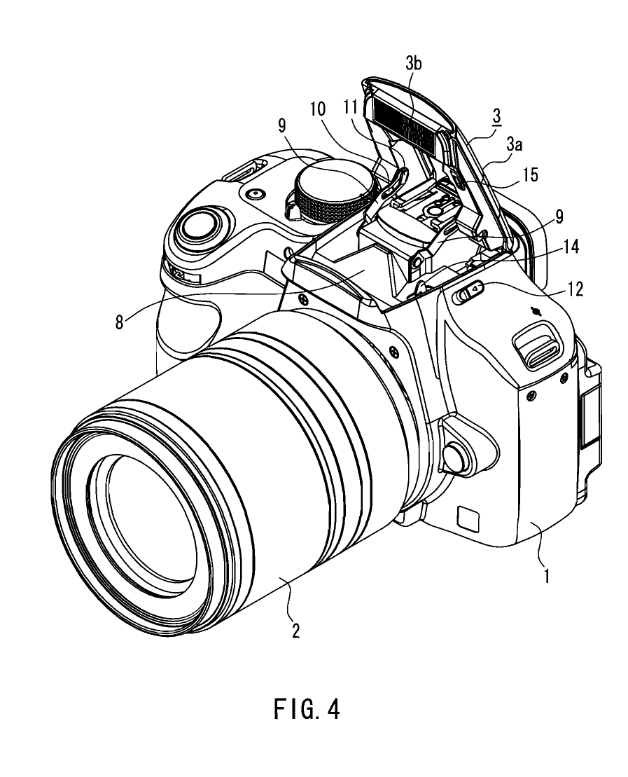

FIG. 1 is a perspective view showing an outer appearance of a camera with a built-in strobe when a strobe device is placed at a housed position, viewed from a photographer side, in Embodiment 1 of the present invention. FIG. 2 is a perspective view showing an outer appearance of the camera with a built-in strobe when the strobe device is placed at a protruding position, viewed from the photographer side, in Embodiment 1 of the present invention. FIG. 3 is a perspective view showing an outer appearance of the camera with a built-in strobe when the strobe device is placed at the housed position, viewed from a subject side, in Embodiment 1 of the present invention. FIG. 4 is a perspective view showing an outer appearance of the camera with a built-in strobe when the strobe device is placed at the protruding position, viewed from the subject side, in Embodiment 1 of the present invention. In the present embodiment, a digital single-lens reflex camera will be exemplified as a camera with a built-in strobe.

As shown in FIGS. 1 to 4, the camera with a built-in strobe of the present embodiment generally is composed of a camera body 1, a barrel 2, and a strobe device 3.

The barrel 2 is attached removably to the camera body 1, and a plurality of lenses such as a zoom lens and a focus lens are contained in the barrel 2. Furthermore, a zoom ring allowing a manual zoom operation and a focus ring allowing a manual focus operation are provided rotatably on a cylindrical surface of the barrel 2.

The camera body 1 contains an image pickup element that forms an optical image incident through the lenses in the barrel 2, and converts the optical image into an electric signal and outputs it, a signal processing circuit that generates a video signal based on the electric signal output from the image pickup element, an information medium on which the video signal processed in the signal processing circuit is recorded, and the like.

Furthermore, the camera body 1 is provided with a viewfinder 4, a liquid crystal monitor 5, a release button 6, and the like.

The viewfinder 4 is configured so as to recognize visually an optical image that is incident through the lenses in the barrel 2, reflected from a mirror placed on an optical axis in the camera body 1, and reflected from the inside of a pentaprism. In the present embodiment, the digital single-lens reflex camera is exemplified, so that optical mechanisms such as a mirror and a prism are contained in the camera body 1. However, in the case of cameras other than the single-lens reflex camera, the above-mentioned optical mechanisms are omitted.

The liquid crystal monitor 5 can display videos and various kinds of information. Specifically, the liquid crystal monitor 5 can display an image (a so-called through-image) formed to be generated by the image pickup element placed on the optical axis in the camera body 1 during photographing, and can display an image read from an information medium such as a memory card mounted in the camera body 1 during reproduction. Furthermore, the liquid crystal monitor 5 can display information required during the use of the camera with a built-in strobe, such as a zoom magnification value, a diaphragm value, a battery remaining amount, and the photograph number.

When a photographer presses the release button 6, an image (for example, a still-image) picked up by the image pickup element can be recorded on an information medium. Furthermore, the release button 6 is configured so as to receive a half-pressing operation and a full-pressing operation. Then, the release button 6 is pressed halfway, whereby an autofocusing operation can be performed. Furthermore, the release button 6 is pressed fully, whereby an image can be captured.

The strobe device 3 is provided on an upper surface of the camera body 1, and can emit auxiliary light during photographing.

### 2. Configuration Around a Strobe Device

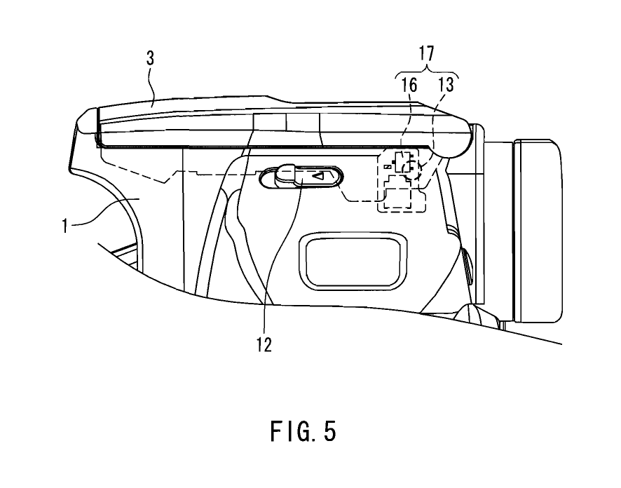

The configuration around a strobe device will be described also with reference to FIGS. 5 to 7.

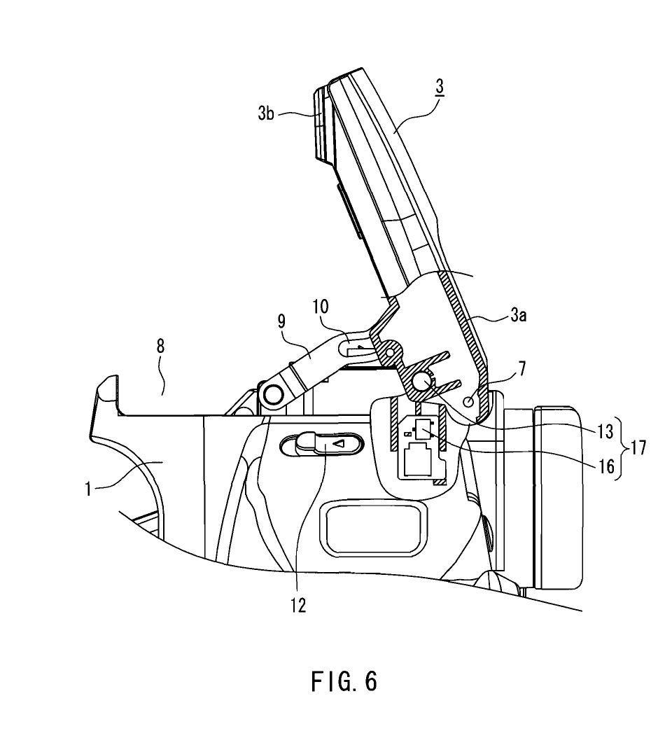

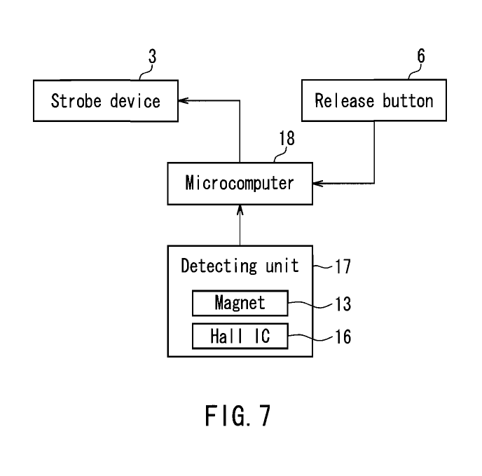

FIG. 5 is a side view showing a configuration around a strobe device when the strobe device is placed at a housed position in the camera with a built-in strobe in Embodiment 1 of the present invention. FIG. 6 is partially cut-away side view showing a configuration around the strobe device when the strobe device is placed at a protruding position in the camera with a built-in strobe in Embodiment 1 of the present invention. FIG. 7 is a schematic block diagram illustrating a light-emitting circuit of the strobe device in Embodiment 1 of the present invention.

As shown in FIGS. 1 to 6, a strobe device 3 includes a strobe case 3a, and a strobe light-emitting portion 3b provided at a tip end of the strobe case 3a, and a wiring portion and a trigger coil are placed in the strobe case 3a. Herein, the wiring portion is, for example, a flexible circuit board made of polyimide, and functions so as to connect the strobe light-emitting portion 3b to the camera body 1 electrically. Then, the strobe light-emitting portion 3b emits auxiliary light in synchronization with the full-pressing operation of the release button 6.

The strobe device 3 is a movable pop-up strobe device that is axially supported rotatably with respect to the camera body 1 via a rotation shaft 7 at a base end of the strobe case 3a (see FIG. 6), and can move between the housed position (shown in FIGS. 1, 3, and 5) and the protruding position (shown in FIGS. 2, 4, and 6). Then, the strobe device 3 is housed in a concave portion 8 (see FIGS. 2, 4, and 6) provided on the upper surface of the camera body 1 at the housed position.

At the base end of the strobe case 3a, an elastic member (not shown) such as a helical spring is attached externally to the rotation shaft 7. Consequently, the strobe device 3 is biased at all times, for example, in a clockwise direction in FIG. 6.

As shown in FIGS. 4 and 6, the rotation in the biased direction of the strobe device 3 is regulated at the protruding position by a stopper member 9. More specifically, one end of the stopper member 9 is axially supported rotatably with respect to the camera body 1, and a slide groove 10 is formed at the other end of the stopper member 9. Furthermore, a slide chip 11 provided at the strobe case 3a is inserted in the slide groove 10. The slide chip 11 can move inside the slide groove 10, following the rotation operation of the strobe device 3, and the slide chip 11 comes into contact with an end face of the slide groove 10 of the stopper member 9 opposite to the axially supported side at the protruding position. Thus, the rotation in the biased direction of the strobe device 3 is regulated, and the strobe device 3 is held at the protruding position shown in FIGS. 2, 4, and 6. At this time, the strobe light-emitting portion 3b of the strobe device 3 is directed forward.

The camera body 1 has a hook 14 that moves in synchronization with a slide operation of a pop-up operation member 12 exposed outside (see FIGS. 2 and 4), and the strobe case 3a has an engagement portion 15 with which the hook 14 is engaged (see FIG. 4). Herein, the hook 14 is always biased by the elastic member (not shown) in a direction in which the engagement state with the engagement portion 15 is kept when the strobe device 3 is placed at the housed position shown in FIGS. 1, 3, and 5. This can keep the strobe device 3 at the housed position. Then, when the photographer slides the pop-up operation member 12, the hook 14 is disengaged from the engagement portion 15, and the strobe device 3 moves to the protruding position by a bias force of the elastic member such as a helical spring.

As shown in FIGS. 5, 6, and 7, the camera with a built-in strobe of the present embodiment has a detecting unit 17 detecting that the strobe device 3 is placed at a light emittable position.

The detecting unit 17 is composed of a magnet 13, and a Hall element whose value of an output voltage changes depending upon the distance from the magnet 13. The detecting unit 17 detects that the strobe device 3 is placed at a light emittable position based on the output voltage signal from the Hall element. Thus, in the present embodiment, a non-contact-type unit composed of the magnet 13 and the Hall element is used as the detecting unit 17, so that there arise no problems peculiar to the contact-type unit in which contact members are welded while a push switch or the like is being pushed, making it impossible to switch between ON and OFF.

Herein, the Hall element is integrated with a peripheral circuit such as a binarizing circuit to form a Hall IC 16.

Furthermore, as the magnet 13, a permanent magnet such as a samarium-cobalt based rare earth magnet or a neodymium based rare earth magnet is used. Although an electromagnet can be used as the magnet 13, it is preferred to use a permanent magnet in terms of the reduction in power consumption.

The Hall IC 16 containing the Hall element is provided in the camera body 1, and the magnet 13 is provided in the strobe case 3a of the strobe device 3. Thus, the Hall IC 16 and the magnet 13 are provided respectively in the camera body 1 and the strobe case 3a of the strobe device 3 independently, whereby the switching between the emission prohibition and the emission permission of the strobe device 3 can be performed so as to be associated with the movement (pop-up operation) between the housed position and the projection position.

The Hall element contained in the Hall IC 16 and the magnet 13 are placed so as to be closest to each other when the strobe device 3 is placed at the housed position (state in FIG. 5). Then, as the strobe device 3 moves from the housed position to the protruding position (FIG. 6), the distance between the Hall element and the magnet 13 increases. Therefore, the value of the output voltage from the Hall element contained in the Hall IC 16 decreases as the strobe device 3 moves from the housed position to the protruding position. Furthermore, an H signal or an L signal is output from the Hall IC 16 in accordance with the distance from the magnet 13. More specifically, when the output voltage from the Hall element is larger than a predetermined threshold value, the Hall IC 16 outputs an H signal indicating that the strobe device 3 is placed at a non-light emittable position. Furthermore, when the output voltage from the Hall element reaches a predetermined threshold value or less, the Hall IC 16 outputs an L signal indicating that the strobe device 3 is placed at the light emittable position. Then, the H signal or the L signal output from the Hall IC 16 is input to a microcomputer 18 that controls the strobe device 3 based on the H signal or the L signal.

The strobe device 3 is configured so as to be placed at the light emittable position when the output voltage from the Hall element reaches a predetermined threshold value or less as described above, whereby the switching position between the emission prohibition and the emission permission of the strobe device 3 can be set freely, and in particular, the switching between the emission prohibition and the emission permission of the strobe device 3 can be performed at a position close to the protruding position. In the present embodiment, the threshold value of the output voltage from the Hall element is set so that the switching between the emission prohibition and the emission permission of the strobe device 3 is performed when the strobe device 3 comes to a position (in the vicinity of the protruding position) at an open angle of about 45° based on the housed position shown in FIG. 5. Then, in the case where the microcomputer 18 contained in the camera body 1 receives a signal corresponding to the full-pressing operation from the release button 6 while receiving the L signal from the Hall IC 16 indicating that the strobe device 3 is placed at the light emittable position, the microcomputer 18 controls the strobe device 3 to allow the strobe light-emitting portion 3b to emit auxiliary light. Herein, the microcomputer 18 determines a diaphragm value, a shutter speed, and ISO sensitivity based on the obtained photometric results under stationary light and photometric results under pre-emission. For these determinations, the microcomputer 18 compares the photometric results under stationary light with the photometric results under pre-emission, thereby grasping the illumination environment of a subject. For example, a diaphragm value, a shutter speed, and ISO sensitivity are determined, for example, depending upon whether the subject is in a dark environment, in a backlight state, or the like.

According to the above-mentioned configuration, the following problem can be solved: in the case where the strobe device 3 is stopped by a so-called malicious operation while moving from the housed position to the protruding position (in a state where the strobe light-emitting portion 3b is directed to the camera body 1) and the strobe light-emitting portion 3b emits light, the camera body 1 may be burnt.

Furthermore, as described above, the strobe device 3 is configured so as to be placed at the light emittable position when the output voltage from the Hall element reaches a predetermined threshold value or less, whereby the attachment positions of the magnet 13 and the Hall IC 16 containing the Hall element can be determined freely to some degree. This can enhance the degree of design freedom.

Furthermore, in the present embodiment, the Hall IC 16 containing the Hall element and the magnet 13 are placed in the vicinity of the rotation shaft 7 of the strobe device 3. Thus, the output voltage from the Hall element in the case where the strobe device 3 is placed in the vicinity of the protruding position can be kept to be a relatively large value by placing the Hall IC 16 containing the Hall element and the magnet 13 in the vicinity of the rotation shaft 7 of the strobe device 3. The reason for this is as follows: compared with the case where the magnet 13 and the Hall IC 16 containing the Hall element are placed at a tip end of the strobe device 3 and in a corresponding portion of the camera body 1, the distance between the Hall element and the magnet 13 in the case where the strobe device 3 is placed in the vicinity of the protruding position does not become so large. Therefore, the threshold value of the output voltage from the Hall element when the switching between the emission prohibition and the emission permission of the strobe device 3 is performed does not become so small, so that the switching between the emission prohibition and the emission permission of the strobe device 3 can be performed exactly and stably. Furthermore, in the present embodiment, the Hall IC 16 containing the Hall element and the magnet 13 are placed in a plane perpendicular to the rotation shaft 7.

3. Operation of a Camera with a Built-In Strobe

The operation of the camera with a built-in strobe configured as described above will be described with reference to FIGS. 1 to 7.

First, the operation of the strobe device 3 moving from the housed position shown in FIGS. 1, 3, and 5 to the protruding position shown in FIGS. 2, 4, and 6 will be described.

As shown in FIGS. 1, 3, and 5, when the strobe device 3 is placed at the housed position, the hook 14 (see FIGS. 2 and 4) on the camera body 1 side is engaged with the engagement portion 15 (see FIG. 4) on the strobe case 3a side, whereby the strobe device 3 is kept at the housed position. More specifically, the strobe device 3 is kept housed in the concave portion 8 (see FIGS. 2, 4, and 6) on the upper surface of the camera body 1. When the strobe device 3 is placed at the housed position as described above, the distance between the Hall element contained in the Hall IC 16 and the magnet 13 is minimum and the output voltage from the Hall element is larger than a predetermined threshold value (the H signal indicating that the strobe device 3 is placed at the non-light emittable position is output from the Hall IC 16 to the microcomputer 18). Therefore, even if the photographer presses the release button 6 fully, the strobe light-emitting portion 3b does not emit auxiliary light.

When the photographer slides the pop-up operation member 12 in this state, the hook 14 on the camera body 1 side is disengaged from the engagement portion 15 on the strobe case 3a side, and the strobe device 3 rotates in the clockwise direction in FIG. 5 with respect to the rotation shaft 7 at the base end due to the bias force of the elastic member such as a helical spring. Then, the slide chip 11 on the strobe case 3a side comes into contact with the end face of the slide groove 10 of the stopper member 9 opposite to the axially supported side of the stopper member 9, whereby the rotation in the bias direction of the strobe device 3 is regulated, and the strobe device 3 is kept at the protruding position shown in FIGS. 2, 4, and 6.

As described above, in the camera with a built-in strobe of the present embodiment, the threshold value of the output voltage from the Hall element is set so that the switching between the emission prohibition and the emission permission of the strobe device 3 is performed when the strobe device 3 comes to a position (in the vicinity of the protruding position) at an open angle of about 45° based on the housed position shown in FIG. 5. Thus, when the photographer presses the release button 6 fully after the strobe device 3 reaches the protruding position, the strobe light-emitting portion 3b emits auxiliary light in synchronization.

Next, the operation of the strobe device 3 moving from the protruding position shown in FIGS. 2, 4, and 6 to the housed position shown in FIGS. 1, 3, and 5 will be described.

In FIGS. 2, 4, and 6, the strobe device 3 is biased by the elastic member such as a helical spring, and the slide chip 11 on the strobe case 3a side comes into contact with the end face of the slide groove 10 of the stopper member 9 opposite to the axially supported side of the stopper member 9 and is held at the protruding position.

When the photographer presses the upper surface of the strobe case 3a toward the camera body 1 in this state, the strobe device 3 rotates in a counterclockwise direction in FIG. 6 with respect to the rotation shaft 7 at the base end against the bias force of the elastic member such as a helical spring.

Then, when the photographer continues to press the upper surface of the strobe case 3a toward the camera body 1, the hook 14 on the camera body 1 side is engaged with the engagement portion 15 on the strobe case 3a side, whereby the strobe device 3 is kept at the housed position.

In the present embodiment, the pop-up operation of the strobe device 3 is started manually (the slide operation of the pop-up operation member 12 by the photographer). However, the pop-up operation of the strobe device 3 may be started automatically in the case where the camera with a built-in strobe determines it necessary that the strobe light-emitting portion 3b emits light.

### Embodiment 2

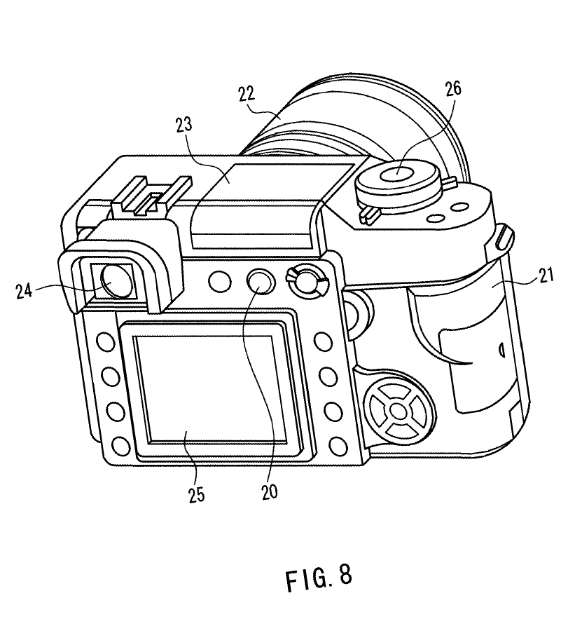

Next, a camera with a built-in strobe capable of performing so-called bounce photographing will be described, in which light from a strobe light-emitting portion strikes a ceiling or the like and is reflected therefrom to illuminate the entire indoor space including not only an object to be photographed but also things behind the object to be photographed, with reference to FIGS. 8 to 11.

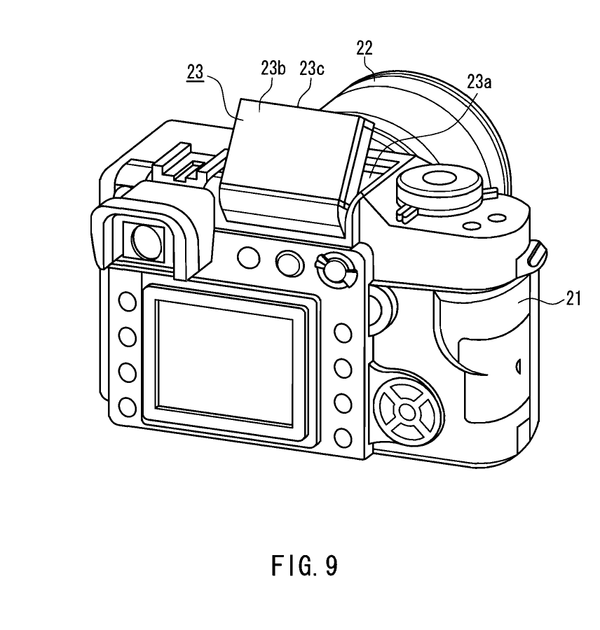

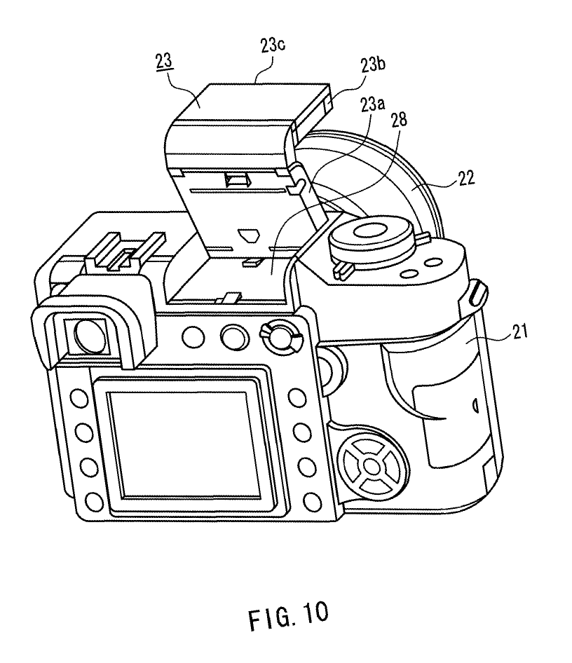

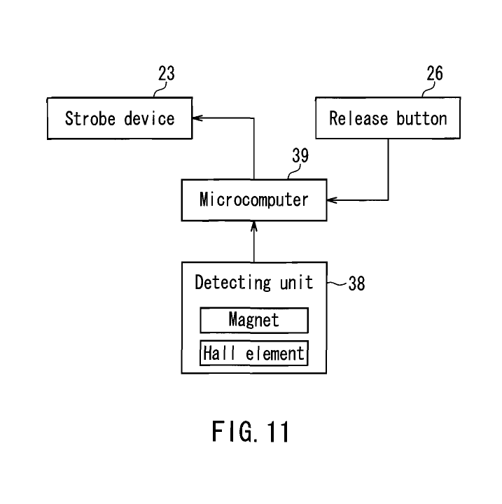

FIG. 8 is a perspective view showing an outer appearance of a camera with a built-in strobe when a strobe device is placed at a housed position, viewed from a photographer side, in Embodiment 2 of the present invention. FIG. 9 is a perspective view showing an outer appearance of the camera with a built-in strobe when the strobe device is placed at a bounce photographing position (half-protruding position), viewed from the photographer side, in Embodiment 2 of the represent invention. FIG. 10 is a perspective view showing an outer appearance of the camera with a built-in strobe when the strobe device is placed at a normal photographing position (protruding position), viewed from the photographer side, in Embodiment 2 of the present invention. FIG. 11 is a schematic block diagram showing a light-emitting circuit of the strobe device in Embodiment 2 of the present invention.

1. Overall Configuration of a Camera with a Built-In Strobe

First, the overall configuration of a camera with a built-in strobe will be described.

As shown in FIGS. 8 to 10, the camera with a built-in strobe of the present embodiment generally is composed of a camera body 21, a barrel 22, and a strobe device 23.

The camera body 21 is provided with a viewfinder 24, a liquid crystal monitor 25, a release button 26, and the like.

More specific configurations of the camera body 21 and the barrel 22 are substantially the same as those of the camera with a built-in strobe in Embodiment 1, so that the descriptions thereof will be omitted.

The strobe device 23 is provided on an upper surface of the camera body 21, and can emit auxiliary light during photographing.

### 2. Configuration Around a Strobe Device

Next, the configuration around the strobe device will be described.

As shown in FIGS. 8 to 10, the strobe device 23 of the present embodiment includes a first strobe case 23a, a second strobe case 23b whose base end is axially supported rotatably with respect to the tip end of the first strobe case 23a via a rotation shaft (not shown), and a strobe light-emitting portion 23c provided at a tip end of the second strobe case 23b. Herein, the second strobe case 23b is biased with a spring in a direction in which the angle formed by the first strobe case 23a and the second strobe case 23b increases, and the rotation in the bias direction is regulated mechanically so that the angle formed by the first strobe case 23a and the second strobe case 23b becomes about 45° at maximum (state in FIG. 9). Furthermore, a wiring portion and a trigger coil are placed in the first and second strobe cases 23a and 23b. Herein the wiring portion is, for example, a flexible circuit board made of polyimide, and functions so as to connect the strobe light-emitting portion 23c to the camera body 21 electrically. Then, the strobe light-emitting portion 23c emits auxiliary light in synchronization with the full-pressing operation of the release button 26.

The strobe device 23 is a movable pop-up strobe device that is axially supported rotatably with respect to the camera body 21 via a rotation shaft (not shown) at a base end of the first strobe case 23a (see FIG. 10), and can move among the housed position (position shown in FIG. 8), the bounce photographing position (half-protruding position) (position shown in FIG. 9), and the normal photographing position (protruding position) (position shown in FIG. 10). Herein, the first strobe case 23a is biased with a spring in a direction in which the angle formed by the first strobe case 23a and the bottom surface of a concave portion 28 provided on the upper surface of the camera body 21 increases, and the rotation in the bias direction is regulated mechanically so that the angle formed by the first strobe case 23a and the bottom surface of the concave portion 28 becomes about 45° at maximum (state in FIG. 10). Then, at the housed position, the strobe device 23 is housed in the concave portion 28 while the first and second strobe cases 23a, 23b are folded. At this time, hooks provided respectively at the camera body 21 are engaged with engagement portions provided respectively at the first and second strobe cases 23a, 23b. Furthermore, the strobe light-emitting portion 23c of the strobe device 23 is directed diagonally upward at the bounce photographing position (state in FIG. 9), and directed forward at the normal photographing position (state in FIG. 10).

The camera body 21 is provided with a pop-up operation button 20. Due to the pressing operation of the pop-up operation button 20, the engagement state between the hook provided at the camera body 21 and the engagement portion provided at the second strobe case 23b, and the engagement state between the hook provided at the camera body 21 and the engagement portion provided at the first strobe case 23a are cancelled successively, whereby the strobe device 23 can move successively to the bounce photographing position and the normal photographing position.

The camera with a built-in strobe of the present embodiment includes a detecting unit 38 detecting that the strobe device 23 is placed at the light-emittable position (see FIG. 11).

As shown in FIG. 11, the detecting unit 38 is composed of a magnet and a Hall element whose value of an output voltage changes depending upon the distance from the magnet in the same way as in Embodiment 1. The detecting unit 38 detects that the strobe device is placed at the light-emittable position based on an output voltage signal from the Hall element.

The Hall element is provided in the camera body 21, and the magnet is provided in the second strobe case 23b of the strobe device 23. The Hall element and the magnet are placed so as to be closest to each other when the strobe device 23 is placed at the housed position (FIG. 8). Then, as the strobe device 23 moves from the housed position to the bounce photographing position (FIG. 9) and the normal photographing position (FIG. 10), the distance between the Hall element and the magnet increases. Therefore, the value of the output voltage from the Hall element decreases as the strobe device 23 moves from the housed position to the bounce photographing position and the normal photographing position, and becomes about 0 V at the normal photographing position.

In the present embodiment, when the output voltage from the Hall element reaches predetermined values corresponding to the above-mentioned predetermined positions (bounce photographing position, normal photographing position), the detecting unit 38 outputs a detection signal indicating that the strobe device 23 is placed at the light-emittable position. When a microcomputer 39 contained in the camera body 21 receives a signal corresponding to the full-pressing operation from the release button 26 while receiving a detection signal indicating that the strobe device 23 is placed at the light-emittable position from the detecting unit 38, the microcomputer 39 controls the strobe device 23 to allow the strobe light-emitting portion 23c to emit auxiliary light.

3. Operation of a Camera with a Built-In Strobe

The operation of the camera with a built-in strobe configured as described above will be described with reference to FIGS. 8 to 11.

First, the operation of the strobe device 23 moving from the housed position shown in FIG. 8 to the bounce photographing position shown in FIG. 9 will be described.

When a photographer presses the pop-up operation button 20 once while the strobe device 23 is held at the housed position as shown in FIG. 8, the engagement state between the hook provided at the camera body 21 and the engagement portion provided at the second strobe case 23b is cancelled, and the strobe device 23 moves to the bounce photographing position shown in FIG. 9 to be held due to a spring bias force.

As described above, the camera with a built-in strobe of the present embodiment is configured so that, when the strobe device 23 comes to the vicinity of the bounce photographing position shown in FIG. 9, the detecting unit 38 outputs a detection signal indicating that the strobe device 23 is placed at the light-emittable position. Thus, when the photographer presses the release button 26 fully after the strobe device 23 reaches the bounce photographing position, the strobe light-emitting portion 23c emits auxiliary light in synchronization (bounce photographing).

Next, the operation of the strobe device 23 moving from the bounce photographing position shown in FIG. 9 to the normal photographing position shown in FIG. 10 will be described.

When the photographer presses the pop-up operation button 20 again while the strobe device 23 is held at the bounce photographing position as shown in FIG. 9, the engagement state between the hook provided at the camera body 21 and the engagement portion provided at the first strobe case 23a is cancelled, and the strobe device 23 moves to the normal photographing position shown in FIG. 10 to be held due to a spring bias force.

As described above, the camera with a built-in strobe of the present embodiment is configured so that, when the strobe device 23 comes to the vicinity of the normal photographing position shown in FIG. 10, the detecting unit 38 outputs a detection signal indicating that the strobe device 23 is placed at the light-emittable position. Thus, when the photographer presses the release button 26 fully after the strobe device 23 reaches the normal photographing position, the strobe light-emitting portion 23c emits auxiliary light in synchronization (normal flash photographing).

Next, the operation of the strobe device 23 moving from the normal photographing position shown in FIG. 10 to the housed position shown in FIG. 8 will be described.

When the photographer presses the upper surface of the second strobe case 23b toward the camera body 21 while the strobe device 23 is held at the normal photographing position as shown in FIG. 10, the first and second strobe cases 23a, 23b are folded against a spring bias force, and the hooks at the camera body 21 are engaged with the engagement portions at the first and second strobe cases 23a, 23b, respectively, whereby the strobe device 23 is held at the housed position.

In the present embodiment, although the pop-up operation of the strobe device 23 is started manually (the pressing operation of the pop-up operation button 20 by the photographer), the pop-up operation of the strobe device 23 may be started automatically in the case where the camera with a built-in strobe determines it necessary that the strobe light-emitting portion 23c emits light.

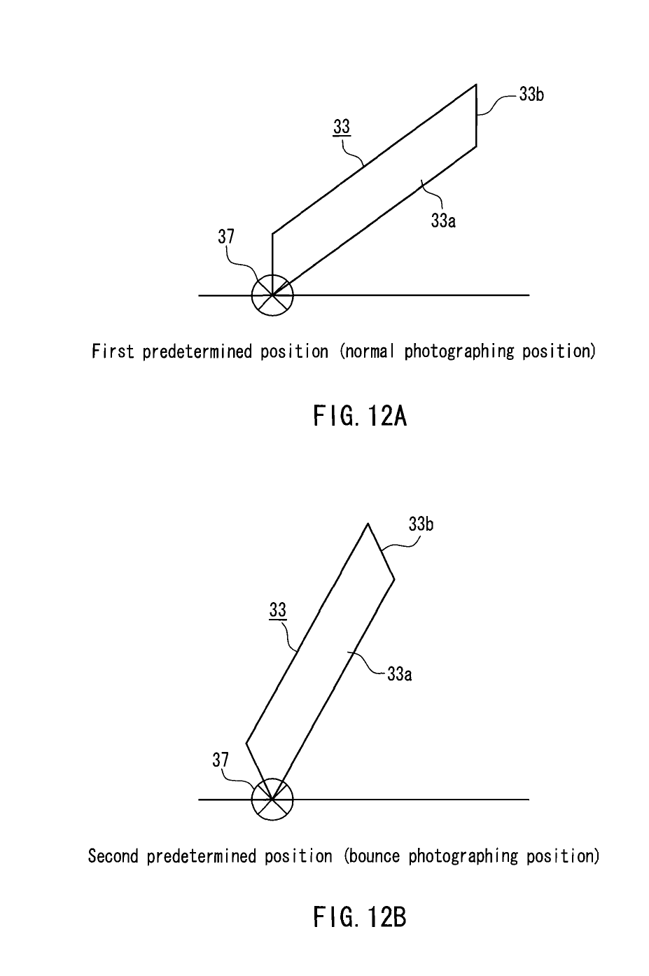

Furthermore, in the present embodiment, the strobe device 23 has been exemplified in which the second strobe case 23b and the first strobe case 23a that are folded perform a pop-up operation successively to the bounce photographing position and the normal photographing position. However, the present embodiment is not necessarily limited to such a configuration. For example, as shown in FIGS. 12A and 12B, even in the case of a strobe device 33 composed of a single strobe case 33a that performs a pop-up operation in an arc shape with respect to a rotation shaft 37, a plurality of predetermined positions can be detected by using a magnet and a hall element. FIG. 12A shows a state in which the strobe device 33 is placed at a first predetermined position (normal photographing position), and a strobe light-emitting portion 33b is directed forward at the first predetermined position (normal photographing position). Furthermore, FIG. 12B shows a state in which the strobe device 33 is placed at a second predetermined position (bounce photographing position), and the strobe light-emitting portion 33b is directed diagonally upward at the second predetermined position (bounce photographing position).

The present invention relates to a camera with a built-in strobe in which the switching position between the emission prohibition and the emission permission of the strobe device can be set freely, and in particular, is useful for a digital still camera and a digital single-lens reflex camera.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A camera with a built-in strobe, comprising:
a camera body;
a movable strobe device provided at the camera body; and
a detecting unit that includes a Hall element provided at the camera body and a magnet provided at the strobe device and detects that the strobe device is at a light emittable position.

2. The camera with a built-in strobe according to claim 1, wherein the strobe device has a plurality of light emittable positions.

3. The camera with a built-in strobe according to claim 2, wherein the plurality of light emittable positions are a normal photographing position and a bounce photographing position.

4. The camera with a built-in strobe according to claim 1, wherein the strobe device is capable of rotating with respect to the camera body, and
the Hall element and the magnet are placed in a vicinity of a rotation shaft of the strobe device.

5. The camera with a built-in strobe according to claim 4, wherein the Hall element and the magnet are placed in a plane perpendicular to the rotation shaft.

6. The camera with a built-in strobe according to claim 1, wherein the magnet is a permanent magnet.
